(19) United States
(12) Patent Application Publication
(10) Pub. No.: US 2005/0034090 A1
(43) Pub. Date: Feb. 10, 2005

(54) Circuit designing method and a circuit designing system

(75) Inventors: Koichi Sato, Kanagawa (JP); Hiroshi Shibuya, Kanagawa (JP); Hitoshi Kurosaka, Kanagawa (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC ELECTRONICS CORPORATION

(21) Appl. No.: 10/623,855

(22) Filed: Jul. 22, 2003

(30) Foreign Application Priority Data
Jul. 23, 2002 (JP) 213895/2002

(51) Int. Cl. G06F 17/50; G06G 7/62; G06F 9/45

(52) U.S. Cl. 716/6; 716/4; 703/13; 703/19

(57) ABSTRACT

A circuit designing method includes steps (a) to (d). The step (a) separates a first algorithm description for a simulation into a hardware portion describing hardware and a software portion describing software, and generating a design data automatically, wherein the design data includes behavior data, architecture data, mapping data and address data. The step (b) generates a first clock base description automatically based on the design data, wherein the first clock base description describes relation between the hardware portion and the software portion. The step (c) generates a second clock base description automatically based on the design data, wherein the second clock base description describes the hardware portion. The step (d) generates a first CPU model automatically based on the design data, wherein the first CPU model describes the software portion. Here, the first clock base description, the second clock base description and the first CPU model are used for verifying the design data.

### BACKGROUND OF THE INVENTION

1. Field of the Invention

The present invention relates to a circuit designing method and a circuit designing system for designing a large scale circuit.

2. Description of the Related Art

Recently, the requirement for developing the multi processing system which is composed of ASIC, CPU, memory and so on is rising. When designing such a system, it makes the algorithm (the algorithm description) which the processing operation of the whole system was produced with the hand. Then, first, this algorithm description is verified. Next, it divides into the part which realizes the algorithm description is separated into one part which will be realized by the hardware such as ASIC and another part which will be realized by the software. After that, as for the part of the hardware (HW), RTL HDL description is produced. As for the part of the software (SW), CPU model is produced. Moreover, after producing top level HDL description, a simulation is carried out by the RTL HDL co-simulation apparatus based on these HDL descriptions and the CPU model.

On the other hand, to build the simulation model which is more accurate than the simulation of the algorithm description and moreover simulates at higher speed than the RTL HDL description, clock base simulation technique is proposed. For example, this clock base (clock level) simulation technique is disclosed in the U.S. patent application Ser. No. 09/686,305 (Japanese Laid Open Patent Application JP-A 2001-109788) and “C++ simulator ‘ClassMate’ for pre-verification on SOC”, Hidefumi Kurokawa, TECHNICAL REPORT OF IEICE, VLD98-46, ICD98-149, FTS98-73 (1998-09).

In this clock base simulation, based on the clock base description, a simulation is executed. As for the clock base description, the degree of the abstraction is lower than the algorithm description and the degree of the abstraction is higher than about the RTL HDL description. As for this clock base description, a bus is abstracted and access to the bus is unified. The access to the target of the bus master is carried out through the abstract bus class.

In conjunction with the above description, a bus interface circuit producing apparatus and a recording media is disclosed into the Japanese Laid Open Patent Application JP-A 2001-117855. The object of this technique is to provide the apparatus that produces the bus interface circuit automatically such that the overlap of registers and addresses of memories is prevented

The bus interface circuit producing apparatus outputs a hardware description language which expresses a bus interface circuit, based on inputs of bus interface description of a bus interface circuit with storage elements and slave hardware description of hardware for slave. It includes an extracting section, a bit data storing section and an address conflict detecting section. The extracting section extracts data regarding addresses of storage elements from the input of bus interface description. The bit data storing section stores addresses to which the storage elements are allocated based on the data extracted by the extracting section. The address conflict detecting section detects the conflict among latest address of the storage element and addresses of storage elements which have already stored, based on the data extracted by the extracting section and stored data of the bit data storing section. Here, the bus interface circuit is arranged between a central processing apparatus for a master and the hardware for slave to the central processing apparatus. The storage element is exemplified in registers, memories and flip-flops. The bus interface description is the description of the storage elements seen from a bus interface at CPU side.

The bus interface circuit producing apparatus may include an RW address comparing section, a judging section and a circuit generating section. The RW address comparing section compares the reading global address and the writing global address agrees those are allocated in the same storage element to search whether or not those addresses are the same, based on the input of the bus interface description. The judging section judges whether or not the reading or writing global address is different from others by a bit. The circuit generating section generates a select signal generating circuit and another circuit those correspond to each address, when the reading global address and writing global address are coincided each other and the global address is different from others by a bit. Here, the select signal generating circuit outputs a select signal activated when the global address is selected. The other circuit converts the global address into a local address of the storage element.

### SUMMARY OF THE INVENTION

A Conventional circuit designing method has processes in which the design is carried out by the hand. It needs labor and moreover is difficult to answer the request to design at the short time. Especially, the automatic generation of the description for the clock base simulation isn't realized.

Therefore, an object of the present invention is to provide a circuit designing method and a circuit designing system which can generates the description for the clock base simulation automatically.

Another object of the present invention is to provide a circuit designing method and a circuit designing system which can generates the top level description of the clock base description for the clock base simulation automatically.

Still another object of the present invention is to provide a circuit designing method and a circuit designing system which can reduces circuit scale when algorithm level description is converted to algorithm description for co-design.

In order to achieve an aspect of the present invention, the present invention provides a circuit designing method including: (a) separating a first algorithm description for a simulation into a hardware portion describing hardware and a software portion describing software, and generating a design data automatically, wherein the design data includes behavior data, architecture data, mapping data and address data; (b) generating a first clock base description automatically based on the design data, wherein the first clock base description describes relation between the hardware portion and the software portion; (c) generating a second clock base description automatically based on the design data, wherein the second clock base description describes the hardware portion; and (d) generating a first CPU model automatically based on the design data, wherein the first CPU model describes the software portion. The first clock base description, the second clock base description and the first CPU model are used for verifying the design data.

The circuit designing method of the present invention, the step (b) includes: (b1) generating an address decoder portion automatically in the first clock base description based on the address data. The address decoder portion describes an address decoder which is arranged between a bus and a CUP interface in the first clock base description and selects an algorithm block from a plurality of algorithm blocks.

The circuit designing method of the present invention, the step (b1) includes: (b11) generating a bus connection between the bus and the address decoder which is described by using a virtual bus in the first clock base description.

The circuit designing method of the present invention, the step (a) includes: (a1) converting the first algorithm description into second algorithm description automatically. It is easier for the second algorithm description to be separated into the hardware portion and the software portion than for the first algorithm description.

The circuit designing method of the present invention, the step (a1) includes: (a11) detecting first algorithm blocks from a plurality of algorithm blocks included in the first algorithm description, wherein data flow in one way between the first algorithm blocks through a global variable; and (a12) replacing the global variable associated to the first algorithm blocks to a port.

The circuit designing method of the present invention, the step (a) includes: (a2) converting the first algorithm description into second algorithm description automatically. It is easier for the second algorithm description to be separated into the hardware portion and the software portion than for the first algorithm description.

The circuit designing method of the present invention, the step (a2) includes: (a21) detecting first algorithm blocks from a plurality of algorithm blocks included in the first algorithm description, wherein data flow in one way between the first algorithm blocks through a global variable; and (a22) replacing the global variable associated to the first algorithm blocks to a port.

The circuit designing method of the present invention, further includes: (e) generating a first HDL description automatically based on the design data, wherein the first HDL description indicates relation between the hardware portion and the software portion; (f) generating a second HDL description automatically based on the design data, wherein the second HDL description indicates the hardware portion; and (g) generating a second CPU model automatically based on the design data, wherein the second CPU model indicates the software portion. The first HDL description, the second HDL description and the second CPU model are used for verifying the design data.

In order to achieve another aspect of the present invention, the present invention provides a circuit designing method including: (h) separating a first algorithm description for a simulation into a hardware portion describing hardware and a software portion describing software, and generating a design data automatically, wherein the design data includes behavior data, architecture data, mapping data and address data; (i) generating a first clock base description automatically based on the design data, wherein the first clock base description describes relation between the hardware portion and the software portion; (j) generating a second clock base description automatically based on the design data, wherein the second clock base description describes the hardware portion; (k) generating a first CPU model automatically based on the design data, wherein the first CPU model describes the software portion; and (l) carrying out the simulation to verify the design data by using the first clock base description, the second clock base description and the first CPU model.

The circuit designing method of the present invention, further includes: (m) generating a first HDL description automatically based on the design data, wherein the first HDL description indicates relation between the hardware portion and the software portion; (n) generating a second HDL description automatically based on the design data, wherein the second HDL description indicates the hardware portion; (o) generating a second CPU model automatically based on the design data, wherein the second CPU model indicates the software portion; and (p) carrying out the simulation to verify the design data by using the first HDL description, the second HDL description and the second CPU model.

In order to achieve still another aspect of the present invention, the present invention provides a circuit designing system including: an algorithm design apparatus; a first clock base description generating apparatus; a second clock base description generating apparatus; and a fist CPU model generating apparatus. The algorithm design apparatus separates a first algorithm description for a simulation into a hardware portion describing hardware and a software portion describing software, and generates a design data automatically, wherein the design data includes behavior data, architecture data, mapping data and address data. The first clock base description generating apparatus generates a first clock base description automatically based on the design data, wherein the first clock base description describes relation between the hardware portion and the software portion. The second clock base description generating apparatus generates a second clock base description automatically based on the design data, wherein the second clock base description describes the hardware portion. The fist CPU model generating apparatus which generates a first CPU model automatically based on the design data, wherein the first CPU model describes the software portion. The first clock base description, the second clock base description and the first CPU model are used for verifying the design data.

The circuit designing system of the present invention, the first clock base description generating apparatus generates an address decoder portion automatically in the first clock base description based on the address data. The address decoder portion indicates an address decoder which is arranged between a bus and a CUP interface in the first clock base description and selects an algorithm block from a plurality of algorithm blocks.

The circuit designing system of the present invention, the first clock base description generating apparatus generates a bus connection between the bus and sad address decoder which is described by using a virtual bus in the first clock base description.

The circuit designing system of the present invention, the algorithm design apparatus converts the first algorithm description into second algorithm description automatically. It is easier for the second algorithm description to be separated into the hardware portion and the software portion than for the first algorithm description.

The circuit designing system of the present invention, the algorithm design apparatus detects first algorithm blocks from a plurality of algorithm blocks included in the first algorithm description, wherein data flow in one way between the first algorithm blocks through a global variable, and replaces the global variable associated to the first algorithm blocks to a port.

The circuit designing system of the present invention, the algorithm design apparatus converts the first algorithm description into second algorithm description automatically. It is easier for the second algorithm description to be separated into the hardware portion and the software portion than for the first algorithm description.

The circuit designing system of the present invention, the algorithm design apparatus detects first algorithm blocks from a plurality of algorithm blocks included in the first algorithm description, wherein data flow in one way between the first algorithm blocks through a global variable, and replaces the global variable associated to the first algorithm blocks to a port.

The circuit designing system of the present invention, further includes: a first HDL description generating apparatus; a second HDL description generating apparatus; and a second CPU model. The first HDL description generating apparatus generates a first HDL description automatically based on the design data, wherein the first HDL description indicates relation between the hardware portion and the software portion. The second HDL description generating apparatus generates a second HDL description automatically based on the design data, wherein the second HDL description indicates the hardware portion. The second CPU model generating apparatus generates a second CPU model automatically based on the design data, wherein the second CPU model indicates the software portion. The first HDL description, the second HDL description and the second CPU model are used for verifying the design data.

In order to achieve yet still another aspect of the present invention, the present invention provides a circuit designing system including: an algorithm design apparatus; a first clock base description generating apparatus; a second clock base description generating apparatus; a fist CPU model generating apparatus; and a clock base simulation executing apparatus. The algorithm design apparatus separates a first algorithm description for a simulation into a hardware portion describing hardware and a software portion describing software, and generates a design data automatically, wherein the design data includes behavior data, architecture data, mapping data and address data. The first clock base description generating apparatus generates a first clock base description automatically based on the design data, wherein the first clock base description describes relation between the hardware portion and the software portion. The second clock base description generating apparatus generates a second clock base description automatically based on the design data, wherein the second clock base description describes the hardware portion. The fist CPU model generating apparatus generates a first CPU model automatically based on the design data, wherein the first CPU model describes the software portion. The clock base simulation executing apparatus which carries out the simulation to verify the design data by using the first clock base description, the second clock base description and the first CPU model.

The circuit designing system of the present invention, further includes: a first HDL description generating apparatus; a second HDL description generating apparatus; a second CPU model generating apparatus, and a HDL simulation executing apparatus. The first HDL description generating apparatus generates a first HDL description automatically based on the design data, wherein the first HDL description indicates relation between the hardware portion and the software portion. The second HDL description generating apparatus generates a second HDL description automatically based on the design data, wherein the second HDL description indicates the hardware portion. The second CPU model generating apparatus generates a second CPU model automatically based on the design data, wherein the second CPU model indicates the software portion. The HDL simulation executing apparatus carries out the simulation to verify the design data by using the first HDL description, the second HDL description and the second CPU model.

In order to achieve another aspect of the present invention, the present invention provides a computer program product embodied on a computer-readable medium and including code that, when executed, causes a computer to perform the following: (a) separating a first algorithm description for a simulation into a hardware portion describing hardware and a software portion describing software, and generating a design data automatically, wherein the design data includes behavior data, architecture data, mapping data and address data; (b) generating a first clock base description automatically based on the design data, wherein the first clock base description describes relation between the hardware portion and the software portion; (c) generating a second clock base description automatically based on the design data, wherein the second clock base description describes the hardware portion; and (d) generating a first CPU model automatically based on the design data, wherein the first CPU model describes the software portion. The first clock base description, the second clock base description and the first CPU model are used for verifying the design data.

The computer program product of the present invention, the step (b) includes: (b1) generating an address decoder portion automatically in the first clock base description based on the address data. The address decoder portion indicates an address decoder which is arranged between a bus and a CUP interface in the first clock base description and selects an algorithm block from a plurality of algorithm blocks.

The computer program product of the present invention, the step (b1) includes: (b11) generating a bus connection between the bus and sad address decoder which is described by using a virtual bus in the first clock base description.

The computer program product of the present invention, the step (a) includes: (a1) converting the first algorithm description into second algorithm description automatically. It is easier for the second algorithm description to be separated into the hardware portion and the software portion than for the first algorithm description.

The computer program product of the present invention, the step (a1) includes: (a11) detecting first algorithm blocks from a plurality of algorithm blocks included in the first algorithm description, wherein data flow in one way between the first algorithm blocks through a global variable; and (a12) replacing the global variable associated to the first algorithm blocks to a port.

The computer program product of the present invention, the step (a) includes: (a2) converting the first algorithm description into second algorithm description automatically. It is easier for the second algorithm description to be separated into the hardware portion and the software portion than for the first algorithm description.

The computer program product of the present invention, the step (a2) includes: (a21) detecting first algorithm blocks from a plurality of algorithm blocks included in the first algorithm description, wherein data flow in one way between the first algorithm blocks through a global variable; and (a22) replacing the global variable associated to the first algorithm blocks to a port.

The computer program product of the present invention, further including: (e) generating a first HDL description automatically based on the design data, wherein the first HDL description indicates relation between the hardware portion and the software portion; (f) generating a second HDL description automatically based on the design data, wherein the second HDL description indicates the hardware portion; and (g) generating a second CPU model automatically based on the design data, wherein the second CPU model indicates the software portion. The first HDL description, the second HDL description and the second CPU model are used for verifying the design data.

In order to achieve still another aspect of the present invention, the present invention provides a computer program product embodied on a computer-readable medium and including code that, when executed, causes a computer to perform the following: (h) separating a first algorithm description for a simulation into a hardware portion describing hardware and a software portion describing software, and generating a design data automatically, wherein the design data includes behavior data, architecture data, mapping data and address data; (i) generating a first clock base description automatically based on the design data, wherein the first clock base description describes relation between the hardware portion and the software portion; (j) generating a second clock base description automatically based on the design data, wherein the second clock base description describes the hardware portion; (k) generating a first CPU model automatically based on the design data, wherein the first CPU model describes the software portion; and (l) carrying out the simulation to verify the design data by using the first clock base description, the second clock base description and the first CPU model.

The computer program product of the present invention, further includes: (m) generating a first HDL description automatically based on the design data, wherein the first HDL description indicates relation between the hardware portion and the software portion;
(n) generating a second HDL description automatically based on the design data, wherein the second HDL description indicates the hardware portion; (o) generating a second CPU model automatically based on the design data, wherein the second CPU model indicates the software portion; and (p) carrying out the simulation to verify the design data by using the first HDL description, the second HDL description and the second CPU model.

### BRIEF DESCRIPTION OF THE DRAWINGS

FIG. 1 is block diagram (with flow chart) showing the structure of the circuit designing system (the circuit designing method) according to the present invention;

FIG. 2A is a block diagram showing an example of the system level algorithm description;

FIG. 2B is a block diagram showing an example of the co-design algorithm description;

FIG. 3A is a diagram showing the system level algorithm description;

FIG. 3B a diagram showing the result of analyzing the system level algorithm description;

FIG. 3C a diagram showing the co-design system level algorithm description converted from the system level algorithm description;

FIG. 4 is the view showing the architecture using the co-design system level algorithm;

FIG. 5 is the view showing the architecture using the system level algorithm description directly;

FIG. 6 shows the mapping by the co-design apparatus;

FIGS. 7 to 9 shows the clock base description of the instance declaration;

FIG. 10 is the block diagram showing the top level clock base description;

FIG. 11 is the block diagram showing the HDL description. In the HDL description;

FIG. 12 is a flow chart showing the operation of the embodiments of the circuit designing system and the circuit designing method according to the present invention;

FIG. 13 represents the structures of a model producing tool and a flow for automatically producing the clock base description;

FIG. 14 is a diagram showing a description structure of the clock base description.

### DESCRIPTION OF THE PREFERRED EMBODIMENTS

Embodiments of a circuit designing system and a circuit designing method according to the present invention will be described below with reference to the attached drawings.

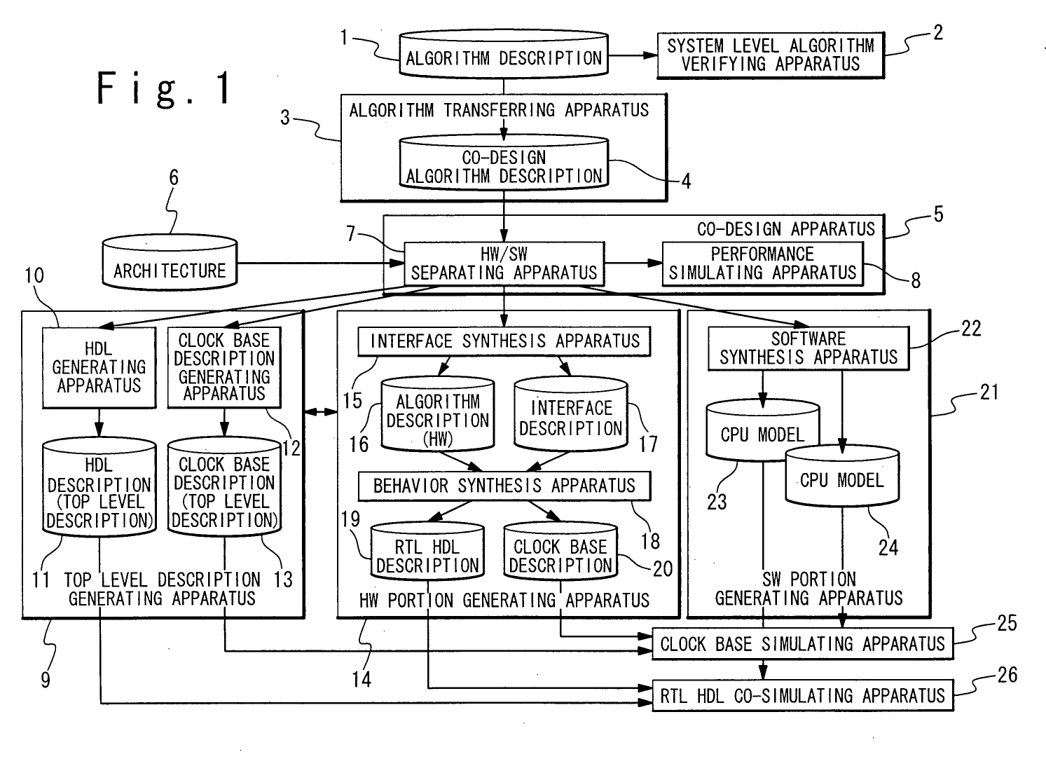

FIG. 1 is block diagram (with flow chart) showing the structure of the circuit designing system (the circuit designing method) according to the present invention.

The circuit designing system includes a system level algorithm verifying apparatus 2, an algorithm transferring apparatus 3, a co-design apparatus 5, a top level description generating apparatus 9, a hardware (HW) portion generating apparatus 14, a software (SW) portion generating apparatus 21. A clock base simulating apparatus 25 and a RTL HDL co-simulating apparatus 26 execute simulations based on data generated by the circuit designing system. Here, the circuit designing system may include the clock base simulating apparatus 25 and the RTL HDL co-simulating apparatus 26.

The system level algorithm verifying apparatus 2 verifies algorithm description 1 (algorithm-level description) by a system level algorithm verifying tool. The algorithm description is described by using programming languages such as C language and C++ language. The system level algorithm verifying tool is exemplified in the SPW produced by Cadence Design Systems Inc. and the COSSAP produced by Synopsys Inc.

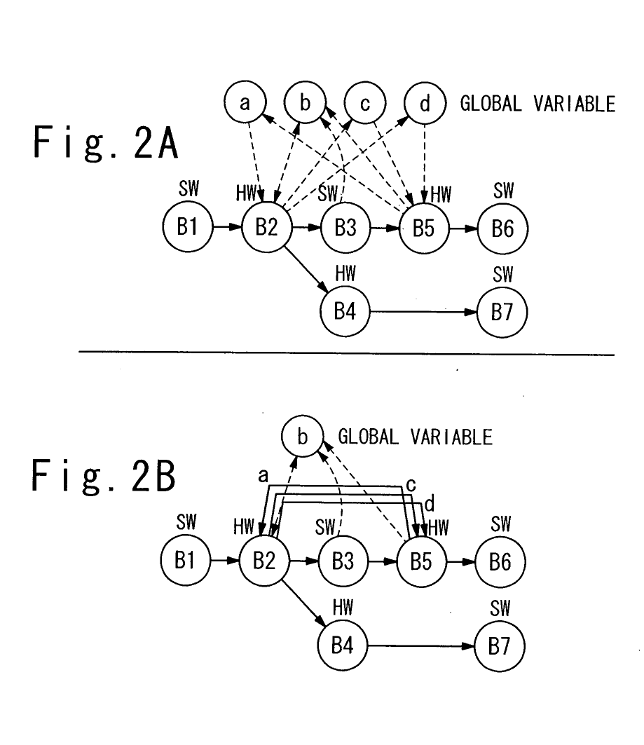

FIG. 2A is a block diagram showing an example of the algorithm description 1 which is verified by the system level algorithm verifying apparatus 2.

In FIG. 2A, each of algorithm blocks B1 to B7 is a block described by the algorithm description. The “a”, “b”, “c” and “d” show global variables. The signal of the algorithm block B1 is inputted to the algorithm block B2. The algorithm block B2 refers the global variables “a” and “b”, and inputs the value to the global variables “b”, “c” and “d”. The signal of the algorithm block B2 is inputted to the algorithm blocks B3 and B4. The algorithm block B3 inputs the value to the global variable “b”, and output the signal to the algorithm block B5. The algorithm block B5 refers the global variables “c” and “d”, and inputs the values to the global variables “a” and “b”. The signal of the algorithm block B5 is inputted to the algorithm block B6. The signal of the algorithm block B4 is inputted to the algorithm block B7. In this way, as for the algorithm description 1 of the system level algorithm verifying apparatus 2, some of the signals are described as ports of each algorithm, however, most of the signals (communication data) are described as global variables. Some of the signals are triggers to start the next block after the last block is finished.

The algorithm transferring apparatus 3 converts the algorithm description 1 to the co-design algorithm description 4. The co-design algorithm description 4 is used for the co-design apparatus 5 and is easy to separate a hardware portion indicating hardware (HW) and a software portion indicating software (SW). The algorithm transferring apparatus 3 processes the algorithm description 1 which has no problem on its algorithm, which is confirmed by the system level algorithm verifying apparatus 2.

The co-design algorithm description 4 is produced by removing the unnecessary global variables from the algorithm description 1 used in the system level algorithm verifying apparatus 2 and converting them to arguments of functions, which are the ports of the algorithm. When an algorithm is described as a block in architecture, it is described like a function, and when global variables is set to the arguments, the argument is treated as a port.

FIG. 2B is a block diagram showing an example of the co-design algorithm description 4 which is generated by the algorithm transferring apparatus 3. The description shown in FIG. 2A is converted to that shown in FIG. 2B. In this way, by using ports for the description, storage elements between algorithms can be reduced and circuit scale can be decreased.

The circuit designing system of the present invention, by setting the algorithm transferring apparatus 3 and processing to remove the global variables, the circuit scale can be decreased. Also, the separating the algorithm description into a portion realized by HW and a portion realized by SW can be carried out easily. The detail is explained later.

The co-design apparatus 5 includes a HW/SW separating apparatus and a performance simulating apparatus 8.

The HW/SW separating apparatus 7 separates the co-design algorithm description 4 into a HW portion described as HW (realized by HW) and a SW portion described as SW (realized by SW). That is, the HW/SW separating apparatus decides architectures by analyzing the various factors regarding the architectures such as which of the algorithm blocks of the co-design algorithm 4 is described as HW and SW and the like. Here, for example, the HW portion is composed of ASIC, and the SW portion is produced on the CPU.

The performance simulating apparatus 8 performs the performance simulation to verify the performance of specified architecture to satisfy the performance requirement. When the performance requirement is not satisfied, the HW/SW separating apparatus 7 selects architectures newly once more. The architectures are used in the architecture 6 (stored in the storage apparatus or inputted from outside through an input terminal).

Concretely, the performance simulating apparatus 8, firstly, provides a architecture diagram for the performance simulation. The architecture diagram is the description of the whole architecture by using architecture instances such as a CPU model, an ASIC model, a RTOS model, a MEMORY model and a BUS model. Then, the performance simulating apparatus 8 carries out the performance simulation considering the delay, while changing the algorithms operated on the architecture instances. The performance simulating apparatus 8 judges whether or not the architectures satisfies the requirement of the performance.

The co-design apparatus 5 generates design data of the architectures, after deciding the architectures. The design data is outputted to the top level description generating apparatus 9, the HW portion generating apparatus 14 and the SW portion generating apparatus 21. The design data includes behavior data, architecture data, mapping data and address data.

The top level description generating apparatus 9 generates top level description which describes the whole architecture including both the HW portion and the SW portion, based on the design data. For Example, the top level description includes the relation between the HW portion and SW portion. The top level description generating apparatus 9 includes a top HDL generating apparatus 10 and a clock base description generating apparatus 12.

The top HDL generating apparatus 10 generates the top level HDL description 11 for the RTL HDL co-simulating apparatus 26, based on the design data. Hereinafter the top level HDL description 11 is referred to as the HDL description 11.

The clock base description generating apparatus 12 generates the top level clock base description 13 for the clock base simulating apparatus 25, based on the design data. Hereinafter the top level clock base description 13 is referred to as a clock base description 13.

HW portion generating apparatus 14 includes an interface synthesis apparatus 15 and a behavior synthesis apparatus 18.

The interface synthesis apparatus 15 generates algorithm description 16 of the HW portion by generating the description for the HW portion of the architectures, based on the design data.

Also, the interface synthesis apparatus 15 generates interface description 17 by synthesizing the interface description connected between the HW portion and the BUS. The behavior synthesis apparatus 18 generates RTL HDL description 19 based on the algorithm description 16 of the HW portion and the interface description 17. Also, the behavior synthesis apparatus 18 generates clock base description 20 based on the algorithm description 16 of the HW portion and the interface description 17. The RTL HDL description 19 is outputted to the RTL HDL co-simulating apparatus 26. The clock base description 20 is outputted to the clock base simulating apparatus 25.

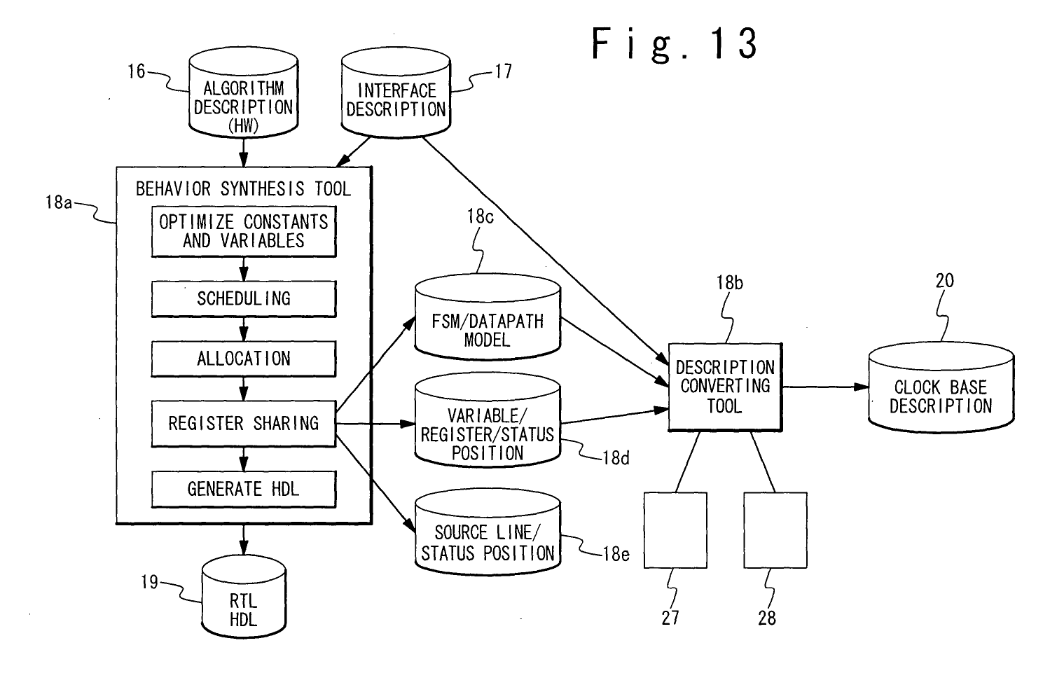

FIG. 13 represents the structures of a model producing tool and a flow for automatically producing the clock base description 20 in the behavior synthesis apparatus 18. This behavior synthesis apparatus 18 uses the technique of U.S. patent application Ser. No. 09/686,305 (the Japanese Laid Open Patent Application (JP-A 2001-109788).

The behavior synthesis tool 18a, which includes a description converting tool 18b, contains a function for optimizing constants and variables, a scheduling function, an allocating function, a register sharing function, and a HDL (hardware level model) producing function. The register sharing function has a function to produce the following three:
(1) an FSM (finite state machine)/DataPath model 18c controlling state transitions of a plurality of register resources used under constraints of the resources by a data path control;
(2) a variable/register/status position correspondence table 18d representing correspondence of a variable, a register, and a status position; and
(3) a source line/status position correspondence table 18e representing correspondence of a source line described in the algorithm description and a status position thereof.

The description converting tool 18b converts the algorithm description 16 into the clock base description 20 based on the interface description 17, the FSM/DataPath model 18c, and the variable/register/status position correspondence table 18d. Thus, the clock base description 20 can be automatically produced from the algorithm description 16. For the automatic production of the clock base description 20, the description converting tool 18b, library data are supplied from a debug function library 27 and a model I/F library 28 to this description converting tool 18b.

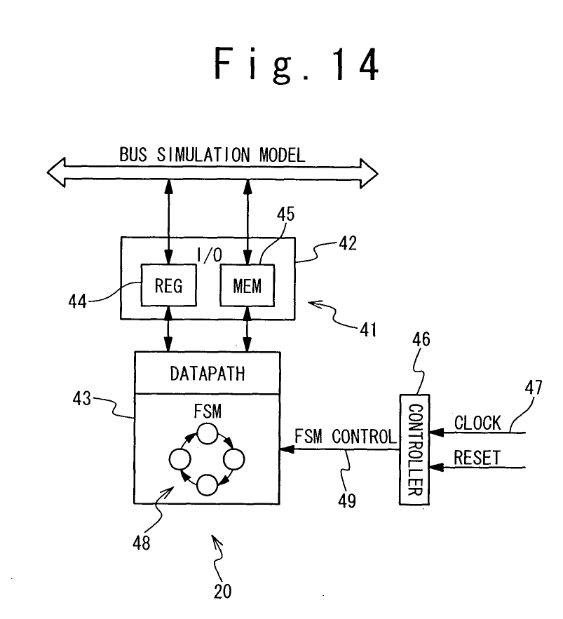

FIG. 14 is a diagram showing a description structure of the clock base description 20. The clock base description 20 is composed of a Bus simulation model 41. The Bus simulation model 41 is composed of a module I/O section 42 and a data path describing section 43. A plurality of I/O registers 44 and a plurality of I/O memories 45 are described in the module I/O section 42. The model I/O section 42 has an I/O register structure and an I/O memory structure. The I/O register structure is produced from the interface description 17, and read/written via an input/output terminal of the bus simulation model 41 by built-in software. The clock base description 20 transfers a signal to another module via a module I/O section. As will be described later, the data path describing section 43 contains data paths for describing relationship between a plurality of I/O registers and a plurality of operators, and also a control structure for controlling an operation in calculation thereof in units of clocks.

A simulation controller 46 is connected to the data path describing section 43. The simulation controller 46 executes a circulate stepwise control (FSM control) of a calculation operation transition 48 in which the clock of the data path describing section 43 is advanced one by one in response to clock input 47 from a simulator main body. An FSM control signal 49 is supplied from the simulation controller 46 to the data path describing section 43.

The SW portion generating apparatus 21 includes a software synthesis apparatus 22.

The software synthesis apparatus 22 generates the CPU model 23 which can operate processes in the RTL HDL co-simulation apparatus 26, based on the design data. The software synthesis apparatus 22 also generates the CPU model 24 which can operate processes in the clock base simulation apparatus 25, based on the design data.

The HDL description 11 generated by the top level description generating apparatus 9, the RTL HDL description 19 generated by the HW portion generating apparatus 14 and the CPU model 23 generated by the SW portion generating apparatus 21 are inputted to the RTL HDL co-simulating apparatus 26. The RTL HDL co-simulating apparatus 26 carries out the total simulation in the RTL HDL description level.

The clock base description 13 generated by the top level description generating apparatus 9, the clock base description 20 generated by the HW portion generating apparatus 14 and the CPU model 24 generated by the SW portion generating apparatus 21 are inputted to the clock base simulating apparatus 25. The clock base simulating apparatus 25 carries out the total simulation in the clock base description level. Here, the clock base description is in the higher level than the RTL HDL description. Therefore, the required time of the simulation carried out by the clock base simulating apparatus 25 is shorter than that carried out by the RTL HDL co-simulating apparatus 26. The required time of the simulation described by the clock base description is approximately one five hundredth of that described by the RTL HDL description.

The clock base simulation (clock-based simulation) keeps the same timing accuracy as that of the actual LSI system in the clock level. Therefore, it can execute the estimation and the verification of the followings.
(1) Verification of operation timings in the clock base of the respective modules,
(2) Rough verification of interfaces of the respective modules (I/O registers, I/O memories, constructions/names/bit widths etc. of I/O terminals),
(3) Estimation of operation clock frequencies of the respective modules/buses,
(4) Estimation of cache access (cache hit rate, access rate, write back time, etc.),
(5) Estimation of access (occupation rate of bus, address, data, master, slave, read/write, and command per bus transaction, word number, occupation time, etc.),
(6) Verification for algorithm of Bus and Arbiter,
(7) Estimation of traffic of memory/IF,
(8) Estimation of throughput of data processing operation (throughput per module, throughput per bus, and throughput per entire system),
(9) Estimation of buffer size and stack size,
(10) Estimation of image quality and sound quality,
(11) Verification of matching characteristics of module interconnection I/F such as address map, terminal, and bit width,
(12) Estimation executed in the case that a floating point is converted into a fixed point,
(13) Development/Debugging operations of installed software, and
(14) Rough estimation of power consumption.

Also, the simulation of the clock base description can speed up the simulation time by omitting some simulation and the like compared with the RTL HDL simulation.

For example, in the RTL-HDL description, since the clock signal is continuously supplied to all of the registers, the register value is continuously updated by either the new data input value or the value saved by this register. To the contrary, in the clock base description, since only such a variable where the data is newly entered is updated, the simulation process operation can be carried out in high speed without unnecessary updating process operation.

In the RTL-HDL description, since the calculator is commonly used, the multiplexer is required which may select one register from a plurality of registers which constitute the input. In the clock base description, there is no limitation in the user of such calculators, namely the calculators need not be commonly used. Moreover, the clock base description need not employ such a multiplexer capable of selecting the inputs of the calculators.

Since the multiplexer is no longer required in order to commonly use the calculators in the clock base description, such a circuit for producing the control input required in the mutiplexer is no longer required.

In the RTL-HDL description, the asynchronous reset signals are supplied to all of the registers. However, in the clock base description, since only the operation in the section of the clock time period is handled, the asynchronous operation need not be carried out.

The RTL-HDL description owns such a structure using the sub-modules, for instance, the registers, the multiplexers, the calculators and so on. The sub-modules have the terminals, and own the signal lines, the control mechanisms, and the like, which are provided inside these sub-modules. In the clock base description, the registers are expressed as the variables of the programming language, the multiplexers are expressed as the condition statements, and the calculators are expressed as the operators. As a consequence, the simulation process operation can be largely simplified.

In the RTL-HDL description, various structural components must be strictly expressed in accordance with the actual hardware as follows: The bit positions of the bundle line are arranged in the ascent/descent order thereof; the code is present, or absent; the signal modes such as integer/bit vector modes are discriminated; and the conversions among these items are carried. To the contrary, these discriminations are not strictly carried out in the clock base description.

The parallel characteristics of the operation among the respective sub-modules realized in the RTL-HDL model are strictly expressed. To the contrary, since the verification is not carried out based upon a difference in the precise operation timing of the respective sub-module in the clock base description, the parallel characteristics of the operation need not be strictly expressed.

In the RTL-HDL description, for example, the operation executed when the reset signal is changed is strictly expressed, while the change timing of the clock signal is strictly expressed. In the clock base description, since only the operation in the section of the clock signal is handled, the process operation with respect to the asynchronous operation can be simplified.

The circuit designing system as explained above realizes the design flow that it decides the architectures (the design data) based on the system level algorithm description and verifies the architectures (the design data) in the clock base level and the RTL HDL level.

Next, the operation (processing) of the embodiments of the circuit designing system and the circuit designing method according to the present invention will be described below with reference to the attached drawings.

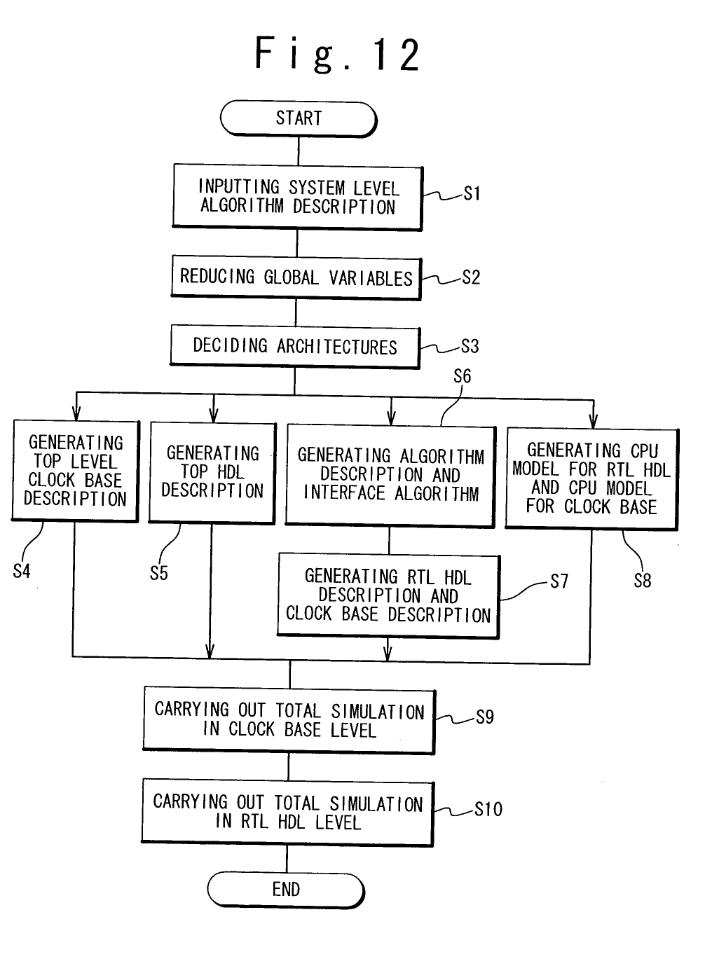

FIG. 12 is a flow chart showing the operation of the embodiments of the circuit designing system and the circuit designing method according to the present invention.

Firstly, the system level algorithm description 1 is inputted from outside such as the automatic description apparatus based on the conceptual design data, the keyboard used by the designer, the communication terminal through the network and the storage apparatus (step S1).

Next, the converting process in which the system level algorithm description 1 is converted to the co-design system level algorithm description 4 will be explained.

This converting process is carried out by the algorithm transferring apparatus 3. For example, the algorithm shown in FIG. 2A is converted to the algorithm shown in FIG. 2B which in which the global variables are reduced as few as possible (step S2).

In this converting process, at first, when the data flows only through one-way, the global variable is converted to simple port. For example, the global variable “a” flows from the B5 to the B2, and the global variables “c” and “d” flow from the B2 to the B5 only through one-way, respectively, as shown in FIG. 2A. Therefore, they are converted to the ports.

FIG. 2B shows the structures after the global variables are converted to the ports. As shown in FIG. 2B, the port is set between the B2 and B5. Here, since the global variable b is accessed by a plurality of the algorithm blocks such as B2, B3 and B5, it can not be converted to the port.

Secondary, the global variable which can not be converted is converted to the behavior memory (memory in the behavior level). For example, the global variable such as the global variable “b” which is accessed by a plurality of the algorithm blocks as shown in FIG. 2A is described as a storage element like a memory. In this case, the circuit is generally described as a memory. A variable is written into the memory by a plurality of modules, and the plurality of modules reads the variable from the memory in some timing.

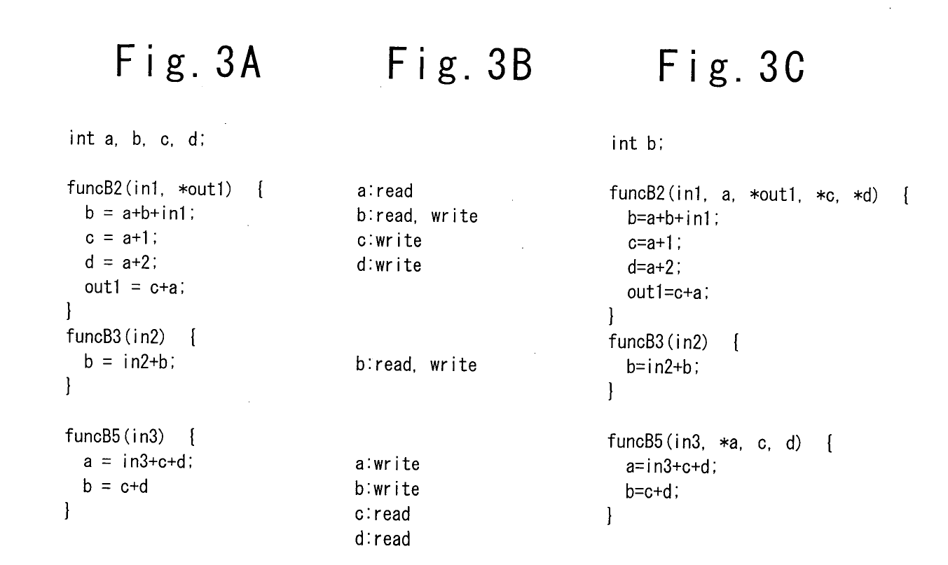

Next, an example of the algorithm of the global variable reducing process which reduces the global variable will be described. FIGS. 3A to 3C shows the example of the description. FIG. 3A shows the system level algorithm description 1 of the algorithm blocks B2, B3 and B5 shown in FIG. 2A. At first, the description in FIG. 3A is analyzed whether or not the global variable of “read” is used and whether or not the global variable of “write” is used. FIG. 3B shows the result of analyzing the system level algorithm description 1. Next, an amount of “read” and that of “write” are calculated respectively. As for FIG. 3B, the result is as follows.
a: read 1 times write 1 time
b: read 2 time, write 3 time
c: read 1 times write 1 time
d: read 1 times write 1 time

When the number of “read” and that of “write” are less than 1, respectively, the global variable can be reduced by converting the global variable to the port. The global variable which can not be reduced is remained as the global variable.

Therefore, the global variables “a”, “c” and “d” can be reduced. The global variable “b” is not reduced and is remained with the same condition. Finally, the functions are converted to the co-design system level algorithm description 4 as shown in FIG. 3C

Next, the process which decides the architectures based on the co-design system level algorithm description 4.

After the global variable reducing process the co-design apparatus decides the architectures. That is, the co-design apparatus 5 decides the architectures while it carries out an performance estimation by using the performance simulating apparatus 8 (step S3).

In this embodiment, the co-design apparatus 5 have functions included in the VCC (Virtual Component Codesign) of Cadence Inc.

HW/SW separating apparatus 7 provides the architecture model (architecture diagram) which operates the processes shown in the algorithm of FIG. 3C. The architecture model is described by arranging the architecture components and wiring among them. The architecture components are exemplified in processors and buses in the architecture 6 characterized on the co-design apparatus 5. At that time, the architectures are composed by the process that the blocks in the co-design algorithm description are separated into the architectures described as HW and that described as SW.

Next, the mapping is carried out by connecting among the components and the interfaces of the architectures, while considering which component executes each block of the algorithm, and through which interface the data of the algorithm flows. GUI may be used for carrying out the mapping.

There is another method for deciding the communication path, which uses “the pattern”. “The pattern” is the protocol of data transfer among the algorithm blocks. As for the communication between HW and SW, it also has the address data of the memory map 10 which corresponds to CPU I/F.

After the mapping, in the performance simulating apparatus 8, the delay factor defined to each architecture component annotates to the algorithm, and then, the simulation is carried out. Therefore, the performance of the algorithm which executed the mapping to the architecture can be verified. When the performance satisfy the requirement, the architecture is decided. After the decision, the design data including behavior data, architecture data, mapping data and address data is generated. Here, the mapping data indicates which component (architecture) in the architecture data carries out a function model of in the behavior data. That is, the mapping data indicates the relation between components (architectures) in the architecture data and function models of in the behavior data. The address data indicate addresses where data is sent or outputted in the architectures. The design data is outputted to the top level description generating apparatus 9, the HW portion generating apparatus 14 and the SW portion generating apparatus 21.

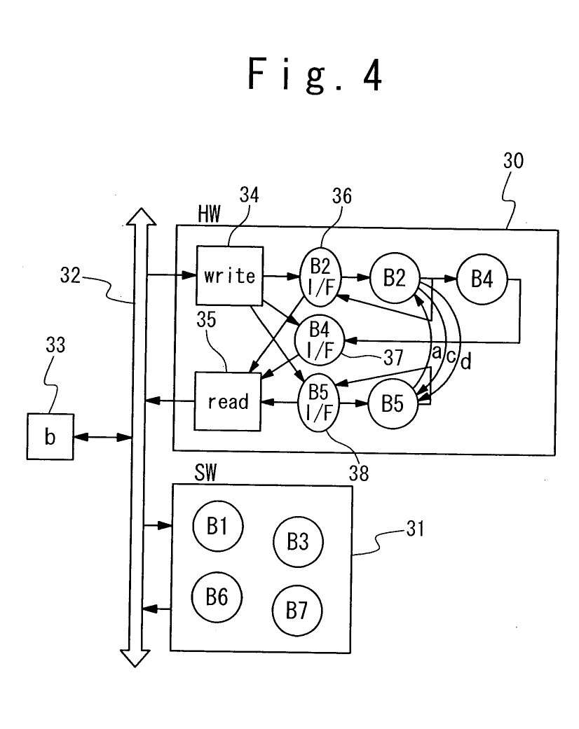

FIG. 4 is the view showing the architecture, based on the architecture data which is generated by separating the algorithm into the HW portion 30 and the SW portion 31 by the HW/SW separating apparatus 7 after the process for removing the global variables.

This structure, corresponds to FIG. 2B, is generated based on the co-design system level algorithm description 4 shown in FIG. 3C and architecture 6. The global variables a, c, and d are converted to the respective ports, and the global variable b is described as a memory 33. In FIG. 4, the algorithms of the HW portion 30 and the SW portion 31 shown in FIG. 2B are carried out the mapping. In the HW portion 30, through a writing portion 34 and a reading portion 35, a bus 32 is connected to a B2 interface 36, a B4 interface 37 and a B5 interface 38. The B2 interface 36, the B4 interface 37 and the B5 interface 38 are automatically generated by the interface synthesizing, and connected to the algorithm block B2, the algorithm block B4 and the algorithm block B5, respectively. In the SW portion 31, the algorithm blocks B1, B3, B6 and B7 are carried out the mapping. The external memory corresponding to the global variable b connects to the bus 32 directly.

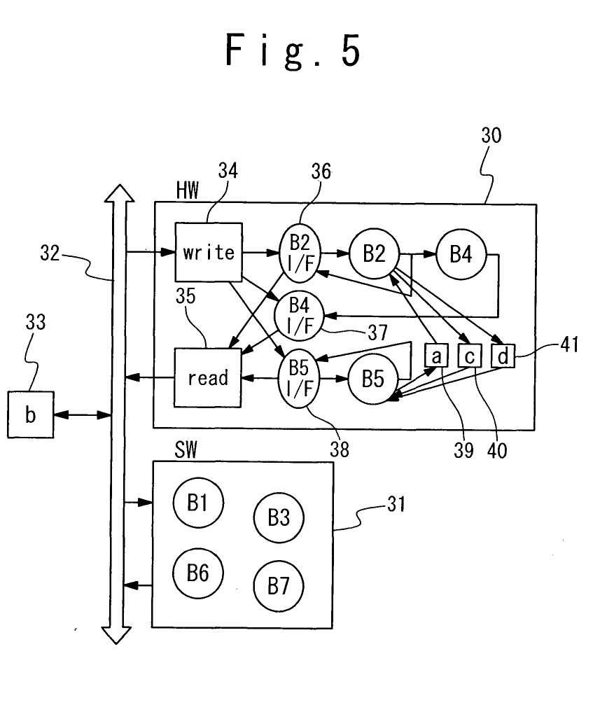

FIG. 5 is the view showing the architecture, based on the architecture data which is generated by separating the algorithm into the HW portion 30 and the SW portion 31 by the HW/SW separating apparatus 7 without doing the process for removing the global variables.

This structure, corresponds to FIG. 2A, is generated based on the co-design system level algorithm description 4 shown in FIG. 3A and architecture 6. The global variables “a”, “c” and “d” are not described as the ports, but described as the memories 39, 40 and 41, respectively. Other structures are the same as that shown in FIG. 4.

Comparing the architectures in FIG. 4 and that in FIG. 5, by the process of separating the algorithm into the HW portion 30 and the SW portion 31 by the HW/SW separating apparatus 7 after the process for removing the global variables, the memories corresponding to the global variables a, c and d can be reduced. Therefore, the circuit scale can be made small for corresponding area of the memories 39, 40 and 41.

Next, the process of the clock base description generating apparatus 12 which is the process between the co-design apparatus 5 and the clock base simulating apparatus 25 will be explained.

The clock base description generating apparatus 12, firstly, generates the top level clock base description 13, based on the design data generated by the co-design apparatus 5 (step S4). The (top level) clock base description 13 is outputted to the clock base simulating apparatus 25.

Here, generating the clock base description 13 will be explained. The clock base generating apparatus 12 automatically generates the clock base description 13 having the format explained as follows.

Format:
Instance declaration
Initialization process, Reset process, Step process
Busread process, Buswrite process
Direct connection between blocks declaration

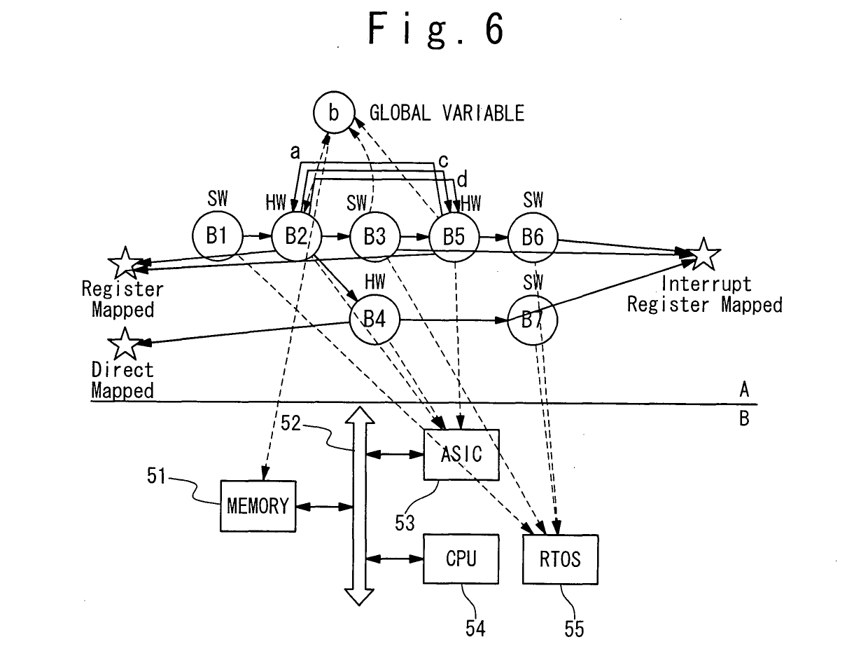

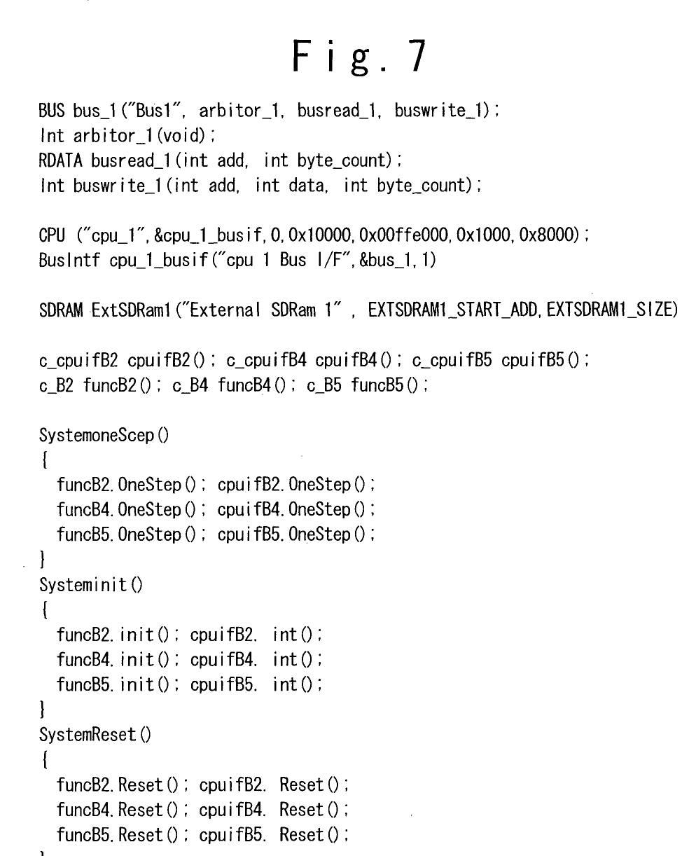

The generation of the instance declaration will be explained. The instance declaration of the clock base description 13 is generated based on the architecture instance and algorithm instance from the mapping data generated by the co-design apparatus. Here, the objects of the instance declaration outputted are existence architecture instances such as processors and buses, algorithms carried out mapping in ASIC and CPU interfaces of the algorithms carried out mapping in ASIC. In case that the mapping by the co-design apparatus 5 is shown in FIG. 6 (A: algorithm, B: architecture diagram), the clock base description generating apparatus 12 generates the clock base description 13 which has the structures shown in the first half of FIG. 7. Upper part (A) of FIG. 6 corresponds to FIG. 2B, and lower part (B) of FIG. 6 corresponds to FIG. 4.

The instance declarations generated from the instances in the architecture diagram are shown below.

The instance declarations of the bus are shown below.

BUS Bus_{—}1 (“Bus1”, arbitor_{—}1, busread_{—}1, buswrite_{—}1);
int arbitor_{—}1 (void);
RDATA busread_(int add, int byte_count);
int buswrite_{—}1 (int add, int data, int byte_count);

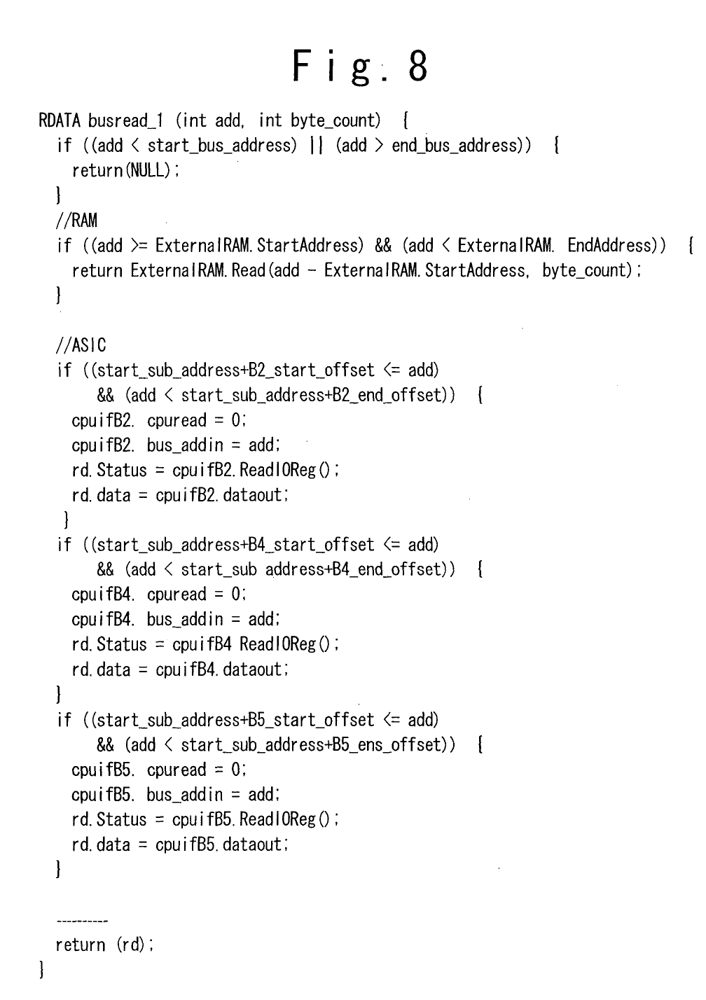

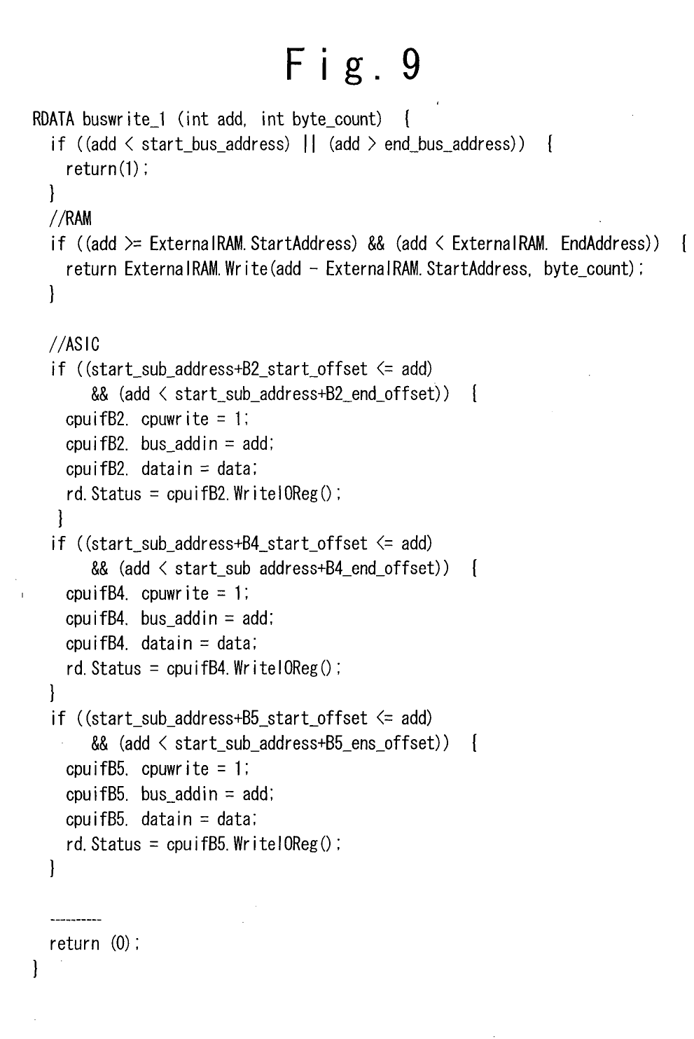

The bus instance itself is declared as “BUS bus_{—}1”, The instance declaration of the “arbitor” is also outputted at the same time. The contents of “arbitor_{—}1” is generated appropriately. When the user wants to change it, he/she edits the clock base description 13. At the same time, the function declaration such as “busread_{—}1” and “buswrite_{—}1” is carried out. These correspond to the blocks described in “busread_{—}1” and “buswrite_{—}1” in FIGS. 8 and 9, and are functions connecting the bus and the CPU I/F of the algorithm in the ASIC. Concretely, addresses for the behavior selection in the memory mapping method are set in them.

The instance declarations of the processors are shown below.

CPU cpu_{—}1 (“cpu_{—}1”, &cpu_{—}1_busif, 0, 0x10000, 0x00ffe000, 0x1000, 0x8000);
BusIntf cpu_{—}1_busif (“cpu 1 Bus I/F”, &bus_{—}1, 1)

In this way, the CPU core and the bus for CPU are set. The numbers correspond to the start addresses of ROM and RAM. As for this data, when the co-design apparatus does not treat, it is not set, and the user will be set later.

The instance declaration of the external ROM and RAM is shown below.
SDRAM ExtSDRam1 (“External SDRam 1”, EXTSDRAM1_START_ADD, EXTSDRAM1_SIZE)

The architecture instance of the memory in the co-design apparatus 5 is converted to this declaration.

The instance declarations of the algorithm carried out the mapping and CPU I/F are shown below.
c_cpuifB2 cpuifB2( ); c_cpuifB4 cpuifB4( ); c_cpuifB5 cpuifB5( );
c_B2 funcB2( ); c_B4 funcB4( ); c_B5 funcB5( );
Here, “c_cpuif***” (an arbitrary function name is in “***”) is a class which describes each “cpuif”. The “c_B**” (an arbitrary algorithm number is in “**”) is a class which describes each algorithm. These class and substance are the clock base description 20 generated by the HW portion generating apparatus 14.

Next, the generation of Initialization process, Reset process and Step process will be explained.

The clock base description 20 is synthesized from the algorithm description 16 and the interface description 17 by the behavior synthesis apparatus 18. The clock base description includes the structure elements such as “Init( )”, “Reset( )” and “OneStep( )”. The “Init( )” is used for initializing the corresponding algorithm block at first. The “Reset( )” is used for setting internal variables initially when the corresponding algorithm block is reset. The “OneStep( )” describes the process in 1 clock when a clock is inputted to the algorithm block. This “OneStep( )” is the core function in the algorithm description. In case that the mapping in the co-design apparatus 5 has the structure shown in FIG. 6, when the blocks operate parallel processing, the clock base description generating apparatus 12 generates the clock base description 13 having the structure shown in the second half of FIG. 7.

That is;

{
funcB2.OneStep( ); cpuifB2.OneStep( );
funcB4.OneStep( ); cpuifB4.OneStep( );
funcB5.OneStep( ); cpuifB5.OneStep( );
}

This description means that the algorithm blocks B2, B4 and B5 operate the parallel processing. The initialization and reset are shown below.

systemInit( )
{
funcB2.Init( ); cpuifB2. Int( );
funcB4.Init( ); cpuifB4. Int( );
funcB5.Init( ); cpuifB5. Int( );
}
systemReset( )
{
funcB2.Reset( ); cpuifB2. Reset( );
funcB4.Reset( ); cpuifB4. Reset( );
funcB5.Reset( ); cpuifB5. Reset( );
}

Next, the generation of the “busread” process and the “buswrite” process is explained.

The “busread” and the “buswrite” are generated based on the address data acquired from the mapping data which is generated by the co-design apparatus 5. The “busread” and the “buswrite” correspond to the algorithm decoder which is between the bus and CPU I/F. FIGS. 8 and 9 are data showing the example of the clock level description 13. The relation among the “cpuif”, the “busread” and the “buswrite” can be shown like FIGS. 8 and 9. The CPU I/F which shown in FIGS. 8 and 9 is generated by the interface synthesis apparatus 15 and the behavior synthesis apparatus 18 by in the HW section generating apparatus 14 from the algorithm description 4. The input description of the interface synthesis apparatus 14 presupposes the technique shown in U.S. patent application Ser. No. 09/689,928 (the Japanese Laid Open Patent JP-A 2001-117855). The algorithm blocks is the clock base description 20 generated by the interface synthesis apparatus 15 and the behavior synthesis apparatus 18 by in the HW section generating apparatus 14 from the algorithm description 4.

In this way, the circuit designing method of the present invention generates “busread” and “buswrite” based on the address data acquired from the mapping data which is generated by the co-design apparatus 5. In the HDL description, since pins corresponding to the bus structure and the bus using method should be specified, it was difficult to automate this processing. On the other hand, the clock base description can produce “busread” and “buswrite” automatically based on the address data because the virtual bus can be used and the pin data need not set in detail. Also, generally, the bus and the CPU I/F is related directly. However, in the circuit designing method of the present invention, the description of “busread” and “buswrite” which correspond to the address decoder is provided.

Next, the generation of the direct connection between blocks declaration will be explained.

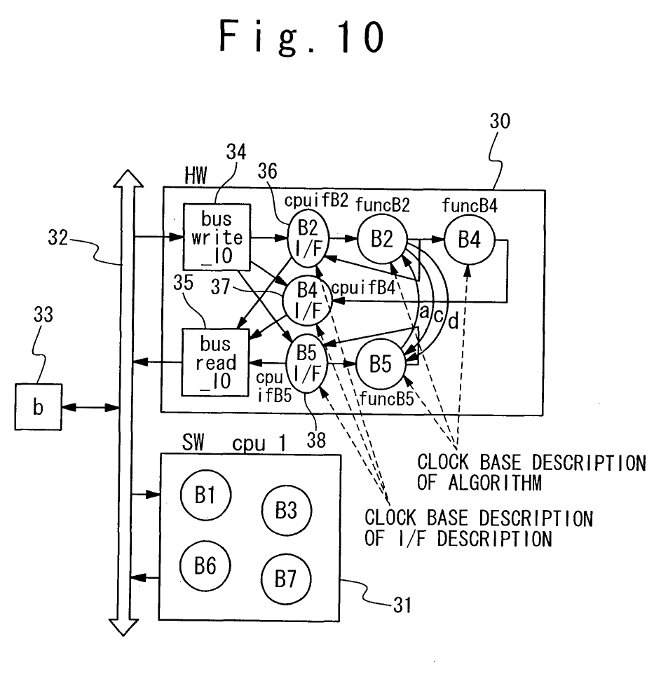

FIG. 10 is the block diagram showing the clock base description 13. The direct connection description between algorithm blocks B2 and B5 in FIG. 10 is generated as shown below.

connection( )
{
B5.a = B2.a;
B5.b = B2.b;
B5.c = B2.c;
}

Here, even though the explanation is omitted, the direct connection is used for the connection between the CPU I/F and the algorithm block. The algorithm blocks B2, B4 and B5 is the clock base description of the algorithm. The B2 I/F, B4 I/F and B5 I/F is the clock base description of the I/F.

The difference between the top level HDL description and the top level clock base description will be explained.

The most different point is the description method for the bus connection. In the clock base description, the bus and the CPU I/F exchange data by using “ReadIORego” and “WriteIOReg( )” of “cpuif”, and the data with the structure as a “RDATA” is handed to the bus.

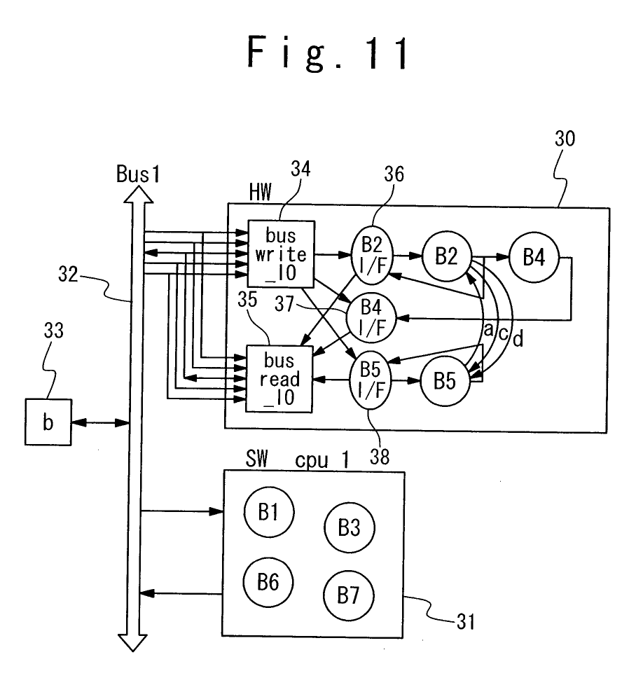

FIG. 11 is the block diagram showing the HDL description. In the HDL description, it is the model that the bus and the CPU I/F is connected by the physical pins as shown in FIG. 11. When the bus is changed, the pin data should be changed and the connection should be also changed. However, the HDL description can be described in the detailed protocol.

In the clock base description, the data is outputted by the structure as a “RDATA”, the exchange of the data is described without the physical structure of bus. However, the detailed bus protocol can not be considered. Therefore, there is a possibility not to estimate the delay accurately rather than the RTL HDL description, depending on how to use the bus.

In this way, the circuit designing method of the present invention, by converting the redundant global variables expression in the algorithm description into the port expression, the circuit scale can be reduced. The co-design algorithm description in the co-design apparatus 5 is converted into the clock base description for the clock base simulating apparatus 25 automatically. Especially, since the present invention synthesizes the top level clock base description automatically, it can reduce the period for constructing the clock base simulation environment.

The top HDL generating apparatus 10 generates the HDL description 11 based on the design data generated by the co-design apparatus 5 (step S5). The HDL description 11 is outputted to the RTL HDL co-simulating apparatus 26.

The interface synthesis apparatus 15 generates the algorithm description 16 and the interface algorithm 17 based on the design data (step S6). The behavior synthesis apparatus 18 generates the RTL HDL description 19 and the clock base description 20 based on the algorithm description 16 and the interface description 17 (step S7). This step uses the technique of U.S. patent application Ser. No. 09/686,305 (the Japanese Laid Open Patent Application (JP-A 2001-109788).

The RTL HDL description 19 is outputted to the RTL HDL co-simulating apparatus 26. The clock base description 20 is outputted to the clock base simulating apparatus 25.

The software synthesis apparatus 22 generates the CPU model 23 and the CPU model 24 based on the design data (step S8). The CPU model 23 is outputted to the RTL HDL co-simulating apparatus 26. The CPU model 24 is outputted to the clock base simulating apparatus 25.

Based on the clock base description 13, the clock base description 20 and the CPU model 24, the clock base simulating apparatus 25 carries out the total simulation in the clock base level (step S9).

Based on the HDL description 11, the RTL HDL description 19 and the CPU model 23, the RTL HDL co-simulating apparatus 26 carries out the total simulation in the RTL HDL level (step S10).

Here, the order of the steps 4, 5, 6 and 8 may be replaced. Also, the steps 4, 5, 6 and 8 may be carried out in parallel.

The present invention can generates the description for the clock base simulation automatically.

The present invention can generates the top level description of the clock base description for the clock base simulation automatically.

The present invention can reduces circuit scale when algorithm level description is converted to algorithm description for co-design.

1. A circuit designing method comprising:
(a) separating a first algorithm description for a simulation into a hardware portion describing hardware and a software portion describing software, and generating a design data automatically, wherein said design data includes behavior data, architecture data, mapping data and address data;
(b) generating a first clock base description automatically based on said design data, wherein said first clock base description describes relation between said hardware portion and said software portion;
(c) generating a second clock base description automatically based on said design data, wherein said second clock base description describes said hardware portion; and
(d) generating a first CPU model automatically based on said design data, wherein said first CPU model describes said software portion,
wherein said first clock base description, said second clock base description and said first CPU model are used for verifying the design data.

2. The circuit designing method according to claim 1, wherein said step (b) includes:
(b 1) generating an address decoder portion automatically in said first clock base description based on said address data,
wherein said address decoder portion describes an address decoder which is arranged between a bus and a CUP interface in said first clock base description and selects an algorithm block from a plurality of algorithm blocks.

3. The circuit designing method according to claim 2, wherein said step (b1) includes:
(b11) generating a bus connection between said bus and sad address decoder which is described by using a virtual bus in said first clock base description.

4. The circuit designing method according to claim 1, wherein said step (a) includes:
(a1) converting said first algorithm description into second algorithm description automatically,
wherein it is easier for said second algorithm description to be separated into said hardware portion and said software portion than for said first algorithm description.

5. The circuit designing method according to claim 4, wherein said step (a1) includes:
(a11) detecting first algorithm blocks from a plurality of algorithm blocks included in said first algorithm description, wherein data flow in one way between said first algorithm blocks through a global variable; and
(a12) replacing said global variable associated to said first algorithm blocks to a port.

6. The circuit designing method according to claim 3, wherein said step (a) includes:
(a2) converting said first algorithm description into second algorithm description automatically,
wherein it is easier for said second algorithm description to be separated into said hardware portion and said software portion than for said first algorithm description.

7. The circuit designing method according to claim 6, wherein said step (a2) includes:
(a21) detecting first algorithm blocks from a plurality of algorithm blocks included in said first algorithm description, wherein data flow in one way between said first algorithm blocks through a global variable; and
(a22) replacing said global variable associated to said first algorithm blocks to a port.

8. The circuit designing method according to claim 1, further comprising:
(e) generating a first HDL description automatically based on said design data, wherein said first HDL description indicates relation between said hardware portion and said software portion;
(f) generating a second HDL description automatically based on said design data, wherein said second HDL description indicates said hardware portion; and
(g) generating a second CPU model automatically based on said design data, wherein said second CPU model indicates said software portion,
wherein said first HDL description, said second HDL description and said second CPU model are used for verifying the design data.

9. A circuit designing method comprising:
(h) separating a first algorithm description for a simulation into a hardware portion describing hardware and a software portion describing software, and generating a design data automatically, wherein said design data includes behavior data, architecture data, mapping data and address data;
(i) generating a first clock base description automatically based on said design data, wherein said first clock base description describes relation between said hardware portion and said software portion;
(j) generating a second clock base description automatically based on said design data, wherein said second clock base description describes said hardware portion;
(k) generating a first CPU model automatically based on said design data, wherein said first CPU model describes said software portion; and
(l) carrying out said simulation to verify the design data by using said first clock base description, said second clock base description and said first CPU model.

10. The circuit designing method according to claim 9, further comprising:
(m) generating a first HDL description automatically based on said design data, wherein said first HDL description indicates relation between said hardware portion and said software portion;
(n) generating a second HDL description automatically based on said design data, wherein said second HDL description indicates said hardware portion;
(o) generating a second CPU model automatically based on said design data, wherein said second CPU model indicates said software portion; and
(p) carrying out said simulation to verify the design data by using said first HDL description, said second HDL description and said second CPU model.

11. A circuit designing system comprising:
an algorithm design apparatus which separates a first algorithm description for a simulation into a hardware portion describing hardware and a software portion describing software, and generates a design data automatically, wherein said design data includes behavior data, architecture data, mapping data and address data;
a first clock base description generating apparatus which generates a first clock base description automatically based on said design data, wherein said first clock base description describes relation between said hardware portion and said software portion;
a second clock base description generating apparatus which generates a second clock base description automatically based on said design data, wherein said second clock base description describes said hardware portion; and
a first CPU model generating apparatus which generates a first CPU model automatically based on said design data, wherein said first CPU model describes said software portion,
wherein said first clock base description, said second clock base description and said first CPU model are used for verifying the design data.

12. The circuit designing system according to claim 11, wherein said first clock base description generating apparatus generates an address decoder portion automatically in said first clock base description based on said address data,
wherein said address decoder portion indicates an address decoder which is arranged between a bus and a CUP interface in said first clock base description and selects an algorithm block from a plurality of algorithm blocks.

13. The circuit designing system according to claim 12, wherein said first clock base description generating apparatus generates a bus connection between said bus and sad address decoder which is described by using a virtual bus in said first clock base description.

14. The circuit designing system according to claim 11, wherein said algorithm design apparatus converts said first algorithm description into second algorithm description automatically,
wherein it is easier for said second algorithm description to be separated into said hardware portion and said software portion than for said first algorithm description.

15. The circuit designing system according to claim 14, wherein said algorithm design apparatus detects first algorithm blocks from a plurality of algorithm blocks included in said first algorithm description, wherein data flow in one way between said first algorithm blocks through a global variable, and replaces said global variable associated to said first algorithm blocks to a port.

16. The circuit designing system according to claim 13, wherein said algorithm design apparatus converts said first algorithm description into second algorithm description automatically,
wherein it is easier for said second algorithm description to be separated into said hardware portion and said software portion than for said first algorithm description.

17. The circuit designing system according to claim 16, wherein said algorithm design apparatus detects first algorithm blocks from a plurality of algorithm blocks included in said first algorithm description, wherein data flow in one way between said first algorithm blocks through a global variable, and replaces said global variable associated to said first algorithm blocks to a port.

18. The circuit designing system according to claim 1, further comprising:
a first HDL description generating apparatus which generates a first HDL description automatically based on said design data, wherein said first HDL description indicates relation between said hardware portion and said software portion;
a second HDL description generating apparatus which generates a second HDL description automatically based on said design data, wherein said second HDL description indicates said hardware portion; and
a second CPU model generating apparatus which generates a second CPU model automatically based on said design data, wherein said second CPU model indicates said software portion,
wherein said first HDL description, said second HDL description and said second CPU model are used for verifying the design data.

19. A circuit designing system comprising::
an algorithm design apparatus which separates a first algorithm description for a simulation into a hardware portion describing hardware and a software portion describing software, and generates a design data automatically, wherein said design data includes behavior data, architecture data, mapping data and address data;
a first clock base description generating apparatus which generates a first clock base description automatically based on said design data, wherein said first clock base description describes relation between said hardware portion and said software portion;
a second clock base description generating apparatus which generates a second clock base description automatically based on said design data, wherein said second clock base description describes said hardware portion;
a fist CPU model generating apparatus which generates a first CPU model automatically based on said design data, wherein said first CPU model describes said software portion; and
a clock base simulation executing apparatus which carries out said simulation to verify the design data by using said first clock base description, said second clock base description and said first CPU model.

20. The circuit designing system according to claim 19, further comprising:
a first HDL description generating apparatus which generates a first HDL description automatically based on said design data, wherein said first HDL description indicates relation between said hardware portion and said software portion;
a second HDL description generating apparatus which generates a second HDL description automatically based on said design data, wherein said second HDL description indicates said hardware portion;
a second CPU model generating apparatus which generates a second CPU model automatically based on said design data, wherein said second CPU model indicates said software portion; and
a HDL simulation executing apparatus which carries out said simulation to verify the design data by using said first HDL description, said second HDL description and said second CPU model.

21. A computer program product embodied on a computer-readable medium and comprising code that, when executed, causes a computer to perform the following:
(a) separating a first algorithm description for a simulation into a hardware portion describing hardware and a software portion describing software, and generating a design data automatically, wherein said design data includes behavior data, architecture data, mapping data and address data;
(b) generating a first clock base description automatically based on said design data, wherein said first clock base description describes relation between said hardware portion and said software portion;
(c) generating a second clock base description automatically based on said design data, wherein said second clock base description describes said hardware portion; and
(d) generating a first CPU model automatically based on said design data, wherein said first CPU model describes said software portion,
wherein said first clock base description, said second clock base description and said first CPU model are used for verifying the design data.

22. The computer program product according to claim 21, wherein said step (b) includes:
(b1) generating an address decoder portion automatically in said first clock base description based on said address data,
wherein said address decoder portion indicates an address decoder which is arranged between a bus and a CUP interface in said first clock base description and selects an algorithm block from a plurality of algorithm blocks.

23. The computer program product according to claim 22, wherein said step (b1) includes:
(b11) generating a bus connection between said bus and sad address decoder which is described by using a virtual bus in said first clock base description.

24. The computer program product according to claim 21, wherein said step (a) includes:
(a1) converting said first algorithm description into second algorithm description automatically,
wherein it is easier for said second algorithm description to be separated into said hardware portion and said software portion than for said first algorithm description.

25. The computer program product according to claim 24, wherein said step (a1) includes:
(a11) detecting first algorithm blocks from a plurality of algorithm blocks included in said first algorithm description, wherein data flow in one way between said first algorithm blocks through a global variable; and
(a12) replacing said global variable associated to said first algorithm blocks to a port.

26. The computer program product according to claim 23, wherein said step (a) includes:
(a2) converting said first algorithm description into second algorithm description automatically,
wherein it is easier for said second algorithm description to be separated into said hardware portion and said software portion than for said first algorithm description.

27. The computer program product according to claim 26, wherein said step (a2) includes:
(a21) detecting first algorithm blocks from a plurality of algorithm blocks included in said first algorithm description, wherein data flow in one way between said first algorithm blocks through a global variable; and
(a22) replacing said global variable associated to said first algorithm blocks to a port.

28. The computer program product according to claim 21, further comprising:
(e) generating a first HDL description automatically based on said design data, wherein said first HDL description indicates relation between said hardware portion and said software portion;
(f) generating a second HDL description automatically based on said design data, wherein said second HDL description indicates said hardware portion; and
(g) generating a second CPU model automatically based on said design data, wherein said second CPU model indicates said software portion,
wherein said first HDL description, said second HDL description and said second CPU model are used for verifying the design data.

29. A computer program product embodied on a computer-readable medium and comprising code that, when executed, causes a computer to perform the following:
(h) separating a first algorithm description for a simulation into a hardware portion describing hardware and a software portion describing software, and generating a design data automatically, wherein said design data includes behavior data, architecture data, mapping data and address data;
(i) generating a first clock base description automatically based on said design data, wherein said first clock base description describes relation between said hardware portion and said software portion;
(j) generating a second clock base description automatically based on said design data, wherein said second clock base description describes said hardware portion;
(k) generating a first CPU model automatically based on said design data, wherein said first CPU model describes said software portion; and
(l) carrying out said simulation to verify the design data by using said first clock base description, said second clock base description and said first CPU model.

30. The computer program product according to claim 29, further comprising:
(m) generating a first HDL description automatically based on said design data, wherein said first HDL description indicates relation between said hardware portion and said software portion;
(n) generating a second HDL description automatically based on said design data, wherein said second HDL description indicates said hardware portion;
(o) generating a second CPU model automatically based on said design data, wherein said second CPU model indicates said software portion; and
(p) carrying out said simulation to verify the design data by using said first HDL description, said second HDL description and said second CPU model.
